(19) United States
(12) Patent Application Publication
(10) Pub. No.: US 2004/0115507 A1
(43) Pub. Date: Jun. 17, 2004

(54) Monolithic fuel cell and method of manufacture

(76) Inventors: Curtis N. Potter, Austin, TX (US); Daniel B. Bullock, The Woodlands, TX (US); Burt W. Fowler, Mountain City, TX (US)

Correspondence Address: Curtis N. Potter, 9308 Rolling Oaks Trail, Austin, TX, 78750, US

(21) Appl. No.: 10/727,436

(22) Filed: Dec. 3, 2003

Related U.S. Application Data
(60) Provisional application No. 60/431,004, filed on Dec. 5, 2002.

(51) Int. Cl. H01M 8/02; H01M 8/10; H01M 8/12; H01M 8/24

(52) U.S. Cl. 429/34; 429/38; 429/30

(57) ABSTRACT

A fuel cell structure and method of manufacture is disclosed that enables very low cost fabrication using conventional semiconductor manufacturing facilities. The fuel cell structure permits fabrication of all the salient features on one side of a single planar substrate. Electrical current extractor lines, electrodes with catalyst, proton exchange membrane, fuel and oxidizer channels, manifolds for each cell and channeled cover plate are all fabricated sequentially through additive and subtractive processing on one side of a planar substrate. The structure provides for ion exchange membrane conduction to take place parallel to the plane of the cell. The design and manufacturing technique allows for the production of a very small elemental cell with high power density. The monolithic structure provides for the stacking of the elemental cells or entire interconnected substrates by virtue of built in fuel and oxidizer manifold chambers fabricated within each elemental cell.

### CROSS REFERENCE TO RELATED APPLICATION

This application claims benefit of U. S. Patent Provisional application Serial No. 60/431,004 filed Dec. 5, 2002. Subject matter set forth in Provisional application serial No. 60/431,004 is hereby incorporated by reference into the present application as if fully set forth herein.

### BACKGROUND OF THE INVENTION

This invention relates to fuel cells and more specifically to fuel cells that can be manufactured using conventional semiconductor fabrication equipment and facilities. The complete fuel cell structure (including top channeled plate) is manufactured sequentially on one side of a planar monolithic substrate.

Fuel cells are devices for converting stored chemical energy directly into electricity generally by using conventional fuels such as hydrogen, methane, methanol and gasoline, for example. The oxidizer commonly used is air or oxygen. The liquid fuels are typically reformed, so called, and hydrogen gas is extracted from the fuel then used by the fuel cell. Hydrogen ions are conducted through a cell membrane to a cathode structure while the ionic properties of the membrane prevent the passage of electrons that have been stripped from the hydrogen gas. Electrons are thus forced to flow through an external load and back to the anode to recombine with the hydrogen ions to form the non-polluting reaction product water. Alternatively hydrogen gas can be used directly with air or oxygen negating the need for a reformer.

Fuel cells provide a convenient solution for electrical energy production with lower levels of point of use pollution especially small compact fuel cells that can replace batteries for portable electronic components such as cell phones and notebook computers, for example. End of life disposal of fuel cells is expected to be less polluting than that of batteries.

Large stationary fuel cells are in use primarily as backup electrical power where power outages cannot be tolerated. These stationary fuel cells may typically range from 1 KW to in excess of 100 KW. Non stationary fuel cells have found application to a limited degree in commercial vehicles such as busses where they use natural gas fuel however the prevalence of such systems is quite limited.

The predominant structure of current fuel cells found in stationary installations is one of component separate parts that are assembled by hand labor. The essential components are a membrane, two electrodes and channeled anode and cathode plates that are assembled together by a variety of means—often simply held in a sandwiched stack by bolting them together. The manufacture and assembly is time consuming and labor intensive. Such an approach to manufacturing extended to small portable fuel cells becomes even more difficult and labor intensive leading to high cost of product.

While there is intense current research and development on the materials that go into the manufacture of the core fuel cell focused to improve efficiency and reliability the manufacturing cost per watt hour is much higher than common current methods of power production such as gasoline generators and batteries, for example.

The fuel cell structure described herein is fabricated on a single side of a flat substrate wherein all the component elements of the fuel cell including membrane, electrodes, catalyst, electrical conductors and fuel and oxidizer channels with outlet feed channels to fuel and oxidizer manifolds are fabricated in a conventional semiconductor fabrication facility. Such fuel cell structure herein described affords the greatest opportunity for manufacturing economy and provides a serious opportunity for the production of fuel cell elements of centimeter square unit cell sizes that can be singulated and stacked or conversely interconnected as an array on a single substrate. Substrate size may be from 4 to 12 inch diameter for example for convenient manufacture in a conventional semiconductor fabrication facility. The structure is fabricated with fuel and oxidizer manifold cavities at the edge of each unit fuel cell enabling the stacking of unit cells or entire substrates for increasing voltage or current output from a stack.

U.S. Pat. No. 4,294,891, to Yao, et al. describes a micro fuel cell that is implantable (in humans) and has a structure that permits refueling through a percutaneous port. Essential components of the fuel cell are fabricated separately then assembled prior to implant.

U.S. Pat. No. 5,641,585, to Lessing, et al. discloses a miniature ceramic fuel cell including an elemental cell with balance of plant. A solid oxide fuel cell is disclosed wherein a planar anode of nickel or zirconium oxide, a planar electrolyte of zirconium oxide, a planar cathode of lanthanum manganese oxide and a planar interconnect of nickel/aluminum are manufactured separately then joined by cobalt/nickel brazing.

U.S. Pat. No. 5,723, 228, to Okamoto describes a direct methanol type fuel cell wherein the design discloses a method for uniformly delivering a proper amount of fluid methanol to an entire anode surface. The structure of the elemental fuel cell comprises an ion exchange membrane, anode, cathode, anode gasket, cathode gasket, and two manifold plates fabricated separately then assembled in registration.

U.S. Pat. No. 6,127,058, to Pratt, et al. discloses a fuel cell demonstrating an integrated anode, cathode and membrane on a single substrate and where the anode and cathode is applied to opposite sides of the membrane. Anode and cathode current collector plates are then attached to the opposite sides of the anode, cathode, membrane assembly.

U.S. Pat. No. 6,312,846, to Marsh discloses a miniature fuel cell that is a departure from prior art wherein the active fuel cell components including membrane, electrodes, fuel and oxidizer channels and current conduction paths are built up on a single, channeled, monolithic substrate through sequential depositions of conductive (electrode) and nonconductive (membrane) polymer. Channels are initially formed in the substrate followed by the application of membrane and electrode material and finally a separate gas impermeable cover seals the structure. Also disclosed is an alternative method of manufacture wherein three grooves (membrane, anode and cathode electrode grooves) are etched into the substrate followed by electrical conductor deposition and finally the injection of flowable membrane material into the center groove. The possibility of introducing semiconductor microcontroller devices onto the substrate for the purpose of monitoring various functions of the fuel cell as well as providing sensing and output power control is disclosed.

U.S. Pat. No. 6,387,559 B1, to Koripella, et al. describes a fuel cell system consisting of a fluid supply array of channels in a base structure with a membrane assembly including separate proton conducting membrane, anode and cathode attached to the channeled substrate. The channeled substrate acts as a partial balance of plant for the insertion of fuel and oxidizer to the membrane assembly part of the fuel cell.

U.S. Pat. No. 6,497,975 B2, to Bostaph, et al. discloses a fuel cell assembly as described in U.S. Pat. No. 6,387,559 above but with the addition of an integrated flow field within an upper and lower plate containing fluid and oxidizer flow channels where the stated purpose is to supply a uniform distribution of fuel and oxidizer to a membrane surface.

U.S. Pat. No. 6,541,149 B1, to Maynard, et al. discloses a micro fuel cell wherein fuel and oxidizer channels are formed on two silicon substrates and where a proton exchange membrane is added to one of the substrates then the two substrates are bonded together to form an elemental cell containing membrane, electrodes, catalysts and current collecting members. In another embodiment the elemental cell is formed on a single substrate through sequential buildup of porous membrane, fuel and oxidizer channels, catalyst and electrodes, current carrying conductors and finally a proton exchange membrane. The unique fabrication process provides for ion conduction essentially in the plane of the substrate.

U.S. Pat. No. 6,638,654, to Jankowski, et al. describes a MicroElectroMechanical Systems (MEMS) based fuel cell consisting of three substrates which are bonded together in registration to form a functional micro fuel cell fabricated using principally semiconductor type processing equipment. A porous membrane and electrode/electrolyte layer is provided on a center substrate, which may be silicon or other material, a channeled top substrate with an O2 inlet is provided and finally a bottom substrate with fuel channel and inlet is provided. The three substrates are bonded together to form an elemental fuel cell. Balance of plant equipment is not described.

U.S. Pat. No. 6,641,948 B1, to Ohlsen, et al. discloses a fuel cell structure comprising an anode assembly and cathode assembly fabricated separately from micromachined silicon wafers wherein the anode and cathode components are bonded together using a third bonding structure and the flow channels within the anode and cathode members are sealed using flow channel covers. The fuel cell is unique in that the current extraction means is through the micromachined silicon substrates.

### BRIEF SUMMARY OF THE INVENTION

A fuel cell structure is disclosed wherein a fully functional fuel cell device is formed on a single side of a substrate. The structure includes a substrate, anode and cathode current extractors, electrodes with integral catalyst, Proton Exchange Membrane (PEM), and fully sealed fuel and oxidizer channels feeding to integral manifolds.

The fully integrated fuel cell is fabricated on a single substrate by sequential additive and subtractive processes commonly used in semiconductor and MEMS fabrication technology.

The objects and advantages obtained by the fuel cell element derive from the alternating anode and cathode electrodes and fuel and oxidizer channels that are structured in a single plane. This enables sequential additive and subtractive processing to complete the invention. Such structure is executed using conventional semiconductor and MEMS microfabrication technology as well as semiconductor packaging technology wherein said technologies are well known in the art.

The structure described utilizes a hydrogen ion flow essentially parallel to the substrate surface resulting in advantageous simplification of the fabrication process in that all of the additive and subtractive processes are planar rather than significantly three dimensional.

The unique planar structure enables the use of insulator materials to be deposited by conventional techniques such as sputtering, evaporation, and chemical vapor deposition, for example. The use of insulator materials are important for the prevention of corrosion and electrical isolation for example.

The planarity of the cell structure is important in minimizing the amount of catalyst used during fabrication. The application of catalyst can be implemented by means of vacuum deposition, plating or chemical vapor deposition and thus restricted to the vicinity of the membrane/electrode interface rather than dispersed throughout the entire electrode structure.

The sequential thin and thick film technology used in fabrication of the fuel cell element along with the design provides a basic structure that takes advantage of fuel cell material improvements that are evolutionary in nature.

The structure design and fabrication process for the fuel cell allows the incorporation of refractory barrier materials within fuel and oxidizer channels as well as anti corrosion layers that can be applied to current extractor lines.

Specifically the entire fuel cell structure is fabricated using conventional semiconductor technology with its' attendant high resolution lithography and high yield for mature processes. Such fabrication capability allows a very wide window of dimensional control in the anode to cathode width of the membrane (few to several hundred micrometers) as well as thickness of the membrane (from a few to several hundred micrometers). Robust, low resistance, plated, current carrying electrodes are enabled using simple plating technology. Uniquely the entire fuel cell structure is fabricated sequentially on a single side of a planar substrate.

### BRIEF DESCRIPTION OF THE DRAWINGS

FIG. 1a illustrates prior art wherein component members are fabricated separately then assembled together in FIG. 1b

FIG. 2 details in an oblique, cutaway view of the salient features and structure of the present embodiment of the invention.

FIG. 3 details a schematic diagram of a fuel cell element of the present invention.

FIGS. 4a through 4g illustrates a preferred embodiment of a fabrication sequence from starting substrate through current extractor electrode fabrication.

FIGS. 5a through 5e indicates a continuation of a preferred embodiment of the fabrication sequence from current extractor barrier metal deposition to proton exchange membrane deposition.

FIGS. 6a through 6edelineates a continuation of the preferred embodiment of the fabrication process from proton exchange membrane deposition through catalyst application to the proton exchange membrane.

FIGS. 7a through 7d illustrates a continuation of the preferred embodiment of the fabrication process from the deposition of the fuel cell electrode material through the resist mask for forming the fuel and oxidizer channels.

FIGS. 8a through 8c illustrates a continuation of the preferred embodiment of the fabrication process from fuel and oxidizer channel wall plateup to the fuel and oxidizer channel wall mask removal.

FIG. 9a shows a top down view of a much reduced in complexity (for the purposes of illustration) fuel cell element indicating the fuel and oxidizer flow channels in the base cell along with (superimposed) the via holes at the end of the channels feeding into channels (bold lines) in the integral cover. Square fuel and oxidizer manifold holes are delineated at the corners of the view which enable stacking of the cells and commutation of fuel or oxidizer source to each of the stacked cells.

FIGS. 9b and 9c illustrate preferred embodiment of the fuel and oxidizer flow paths through the three layer integrally fabricated cover plate to the manifold supply chamber at the edge of the cell. 9b and 9c are derived from sectioning of 9a as indicated in 9a.

FIGS. 10a through 10e illustrates in a preferred embodiment a continuation of the fabrication process performed on the base cell previously processed as illustrated in FIG. 4 through FIG. 8. FIG. 10a illustrates a first masking layer, followed by lithographic patterning, adhesion and preplate layer deposition, a second masking layer with lithographic patterning and finally a selective cover metal plateup in FIG. 10e.

FIGS. 11a through 11d illustrates in a preferred embodiment a continuation of the cover fabrication process from the first cover plateup layer through the application of a second masking and patterning layer to a second adhesion and preplate layer deposition.

FIGS. 12a through 12c illustrates in a preferred embodiment a continuation of the cover fabrication process from the application and patterning of a third masking layer through the plateup of the second metal cover layer.

FIGS. 13a through 13c illustrates in a preferred embodiment a further continuation of the cover fabrication process from application of metal layer 2 through the removal of all masking material from internal channels.

FIG. 14a illustrates the stacking strategy for assembling multiple fuel cell elements for the purpose of increasing power density. A cutaway view illustrates the fuel and oxidizer flow paths from large manifold feed passages through the cell channels thence through vias in the cover plate and along channels in the cover plate back to the exhaust manifold.

FIG. 14b illustrates in a preferred embodiment the strategy for bringing out electrical power to the edge of a stack of cells by exposing an end section of the current carrying feed lines. The figure is shown at 90 degree X-Y plane rotation from the FIG. 14a above.

### DETAILED DESCRIPTION OF THE INVENTION

A micro fuel cell structure and process is disclosed that enables a low cost of manufacture benefit. Although the following detailed description delineates many specific attributes of the invention and describes specific fabrication procedures those skilled in the art of microfabrication will realize that many variations and alterations in the fabrication details are possible without departing from the generality of the preferred embodiment of the structure as described.

The most general attributes of the invention relate to a fuel cell structure that is fabricated wholly on a single substrate wherein all of the salient cell components are sequentially built up using conventional semiconductor or MEMS processing techniques. Ion conduction takes place in a plane predominantly parallel to the substrate. The invention provides for a reduced manufacturing cost benefit derived from the ability to fabricate the entire structure through sequential processing in a semiconductor or MEMS type fabrication facility. A channeled top cover is fabricated sequentially with the basic cell to provide channels and interlayer vias for the removal of fuel and oxidizer. Manifold channels are opened by masking and etching from the back or front side of the monolithic substrate at the end of the process. Arrays of fully functional micro fuel cells are fabricated on a single substrate then singulated for use in small stacked arrays.

Fuel and oxidizer manifolds are partially fabricated at the same time along the edge of unit fuel cells in order that as cells are stacked, edge channels are automatically connected up through the stack and available at the top of the stack for connection to an external source of fuel and oxidizer from balance of plant hardware via an attached tubulation. The completed micro fuel cells can be stacked by soldering or polymer bonding or other means known in sealing art for example to achieve higher output current or voltage.

Optionally entire substrates of interconnected individual fuel cells elements may be stacked to provide a high power fuel cell module. At current state of the art power densities of 0.5 watt per square centimeter an 8 inch diameter substrate containing 150 interconnected cells of 0.5 watts each yield 75 watts. A module of 15 stacked substrates yield 1 KW in a stack volume of 150 cubic centimeters.

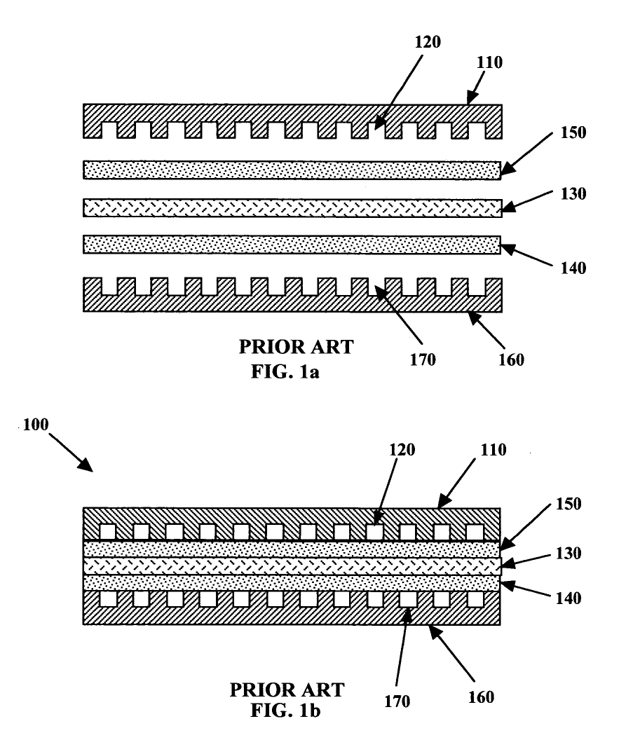

The technology in prior fuel cell art has focused on building both macro and micro cells as component parts. To form a functional fuel cell element the component parts are assembled together in a stack generally with some sort of component feature registration required. FIG. 1a shows in simplified form a fuel cell element 100 consisting of five component parts (balance of plant not included). 110 and 160 are current carrying members fabricated separately while 140 and 150 are electrode members also generally fabricated separately. Membrane 130 is also fabricated separately. These pieces are then bonded together FIG. 1b to form a functional fuel cell element. The assembly process can be expensive and time consuming and does not lend itself to a continuous manufacturing process. Recent interest in micro fuel cell technology for portable electronic applications has resulted in fuel cell designs that are amenable to conventional microfabrication manufacturing techniques. Much of this work has focused on building parts of the fuel cell element separately using conventional microfabrication technology but then assembling the component parts to obtain a fully functional cell. This patent discloses a structure wherein all component parts are integrated within and fabricated sequentially on a single substrate.

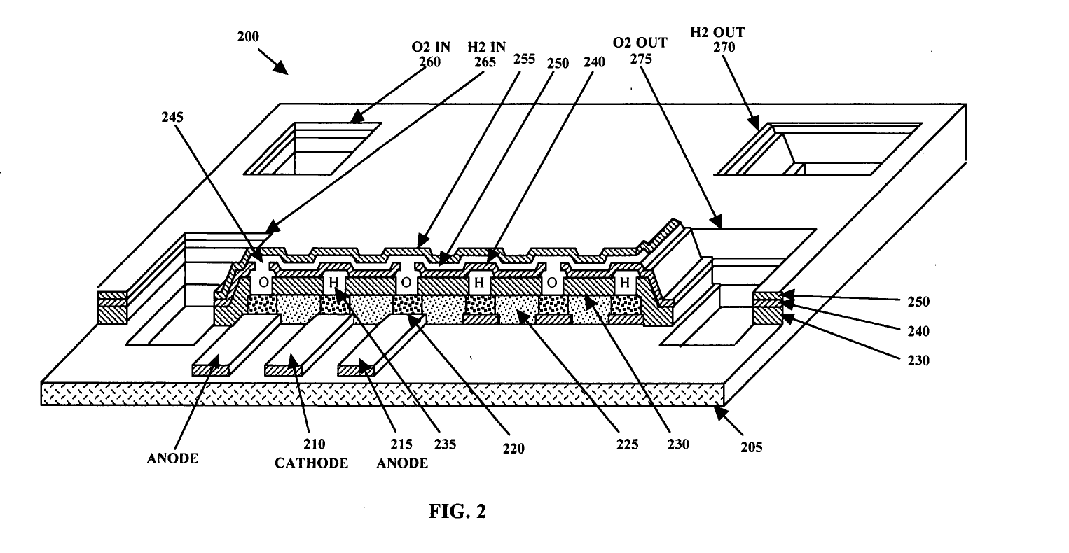

FIG. 2 delineates a cut away view of a preferred embodiment of the disclosed completed monolithic micro fuel cell 200 showing, for simplicity, only the principal components. The fuel cell is built up sequentially using conventional microfabrication techniques on substrate 205. Design of the structure permits fabrication to be executed in a conventional semiconductor fabrication facility that employs thin film deposition equipment, wet and dry etching equipment, plating equipment, lithography equipment, polishing equipment and electrical probing equipment. The fuel cell of FIG. 2 represents a greatly simplified embodiment of an actual cell and the structure represented will be recognized as a functional fuel cell element by those skilled in the art. The fuel cell is fabricated on substrate 205 which can be semiconducting, insulating or metal. The starting substrate is planar and unpatterned in order to be compatible with conventional processing equipment. If the substrate is conducting a first layer (not shown in FIG. 2) of insulator is applied such as silicon nitride, for example. Next a layer of alternating anode 215 and cathode 210 current collector lines are built up by masking and plating technique, for example. Next a continuous layer of proton exchange membrane is applied to the plated anode and cathode surface. It is photomasked and trenches are etched down to the plated anode and cathode current collector lines. Remaining material is heat cured as necessary. Such proton exchange membrane can be applied as a Nafion solution, for example. After trench formation by wet or dry etching technique lines 225 of proton exchange membrane are left between the plated current conductor lines. Next a slurry of electrode material containing a catalyst such as Pt or Pt/Rb is applied by spin coating or doctor blading so as to fill the trenches formed in the proton exchange membrane material. A masking step is utilized to prevent electrode material from being deposited in undesirable regions of the substrate. Electrode material is heat cured as required. Excess electrode material is next removed by mechanical polishing means such that a planarized surface of exposed proton exchange membrane and electrode material result. In order to insulate the metallic fuel and oxidizer channel separators 230 from the proton exchange membrane a layer of insulator (not shown in FIG. 2) is applied to the planarized surface and preferentially removed over the electrodes area by photolithographic patterning. The removal over the electrode area allows for fuel and oxidizer access to the electrode 220 and then laterally through membrane 225. Following selective application of the insulator between 225 and 230 a photomask is applied and used as a plateup mask for fabrication of fuel and oxidizer channel separators 230. It will be noted that suitable masking steps throughout the process are used to insure that no material is deposited in fuel and oxidizer manifold holes 260, 265, 270 and 275.

Further fabrication steps involving an integral, channeled, cover plate can be followed by the aid of FIG. 2. After fabrication of fuel and oxidizer channel separator plates an alternating series of adhesion layer and preplate layer depositions are carried out followed by lithographic masking then plating of the lower cover plate 240. Note that plate 255 is temporarily supported by lithographically patterned resist, (not shown). Plate 240 contains via holes appropriately placed for removal of fuel and oxidizer from the fuel and oxidizer channels. These channels alternate between oxidizer and fuel or oxygen and hydrogen as indicated, for example. Finally the last solid top plate 255 is fabricated using lithographically patterned resist in a process identical to plate 240 fabrication. Buildup of plate 255 leaves channels 250 between plates 240 and 255. After plate 255 fabrication the temporary support resist is removed from buried channels and vias using a hot, circulated compatible solvent. A final step in the fabrication process removes the substrate material at manifold cutout regions 260, 265, 270 and 275 by using wet or dry etching technique (depending on the nature of the substrate material) by masking and patterning the bottom side of the substrate while protecting the previously patterned upper side. Alternatively, and preferably, the top side of the substrate can be masked and patterned and etching of manifold cavities accomplished from the top side while protecting the back side of the substrate.

The aforementioned fuel cell element is a completely functional fuel cell (minus balance of plant) fabricated by sequential processing on a single substrate. Connection to balance of plant is accomplished through attachment of tubulations to manifold cutout regions 260,265, 270 and 275 by various means such as soldering, epoxy seal, o-ring pressure seal, for example.

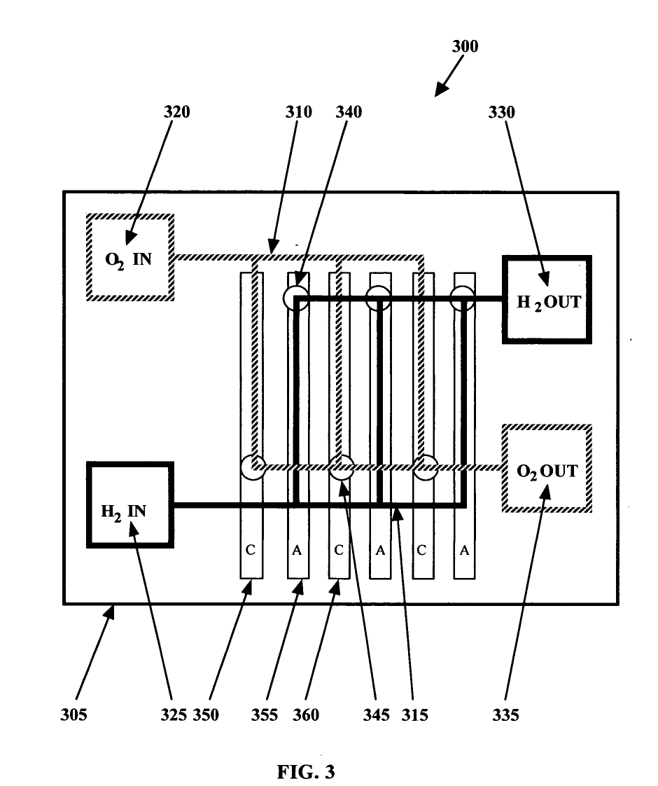

A FIG. 3 block diagram illustrates the essence of the fuel cell shown in FIG. 2. FIG. 3 presents a simplified layout from top view of a much reduced version of an actual cell which may contain up to hundreds of flow channels and current extracting electrodes. The fuel cell is built up on substrate 305 which is the same as substrate 205 in FIG. 2. Fuel, hydrogen, for example, is introduced into manifold channel 325 and is distributed through comb structured channels 315 in the lower part of the fuel cell then flows up through vias 340 to an exit channel in the upper cover where it flows into manifold channel 330. In a like manner oxidizer, oxygen or air, for example is introduced into manifold channel 320 where it flow into distribution channel 310 and then through comb fingers to vias 345 in the cover plate then exits at manifold channel 335. Fuel and oxidizer reaction channels are directly over alternating cathode current extractors 350 and anode current extractors 355. These alternating anode and cathode current extractors serve as connections to a load and can be series or parallel interconnected depending on current or voltage levels of output power required.

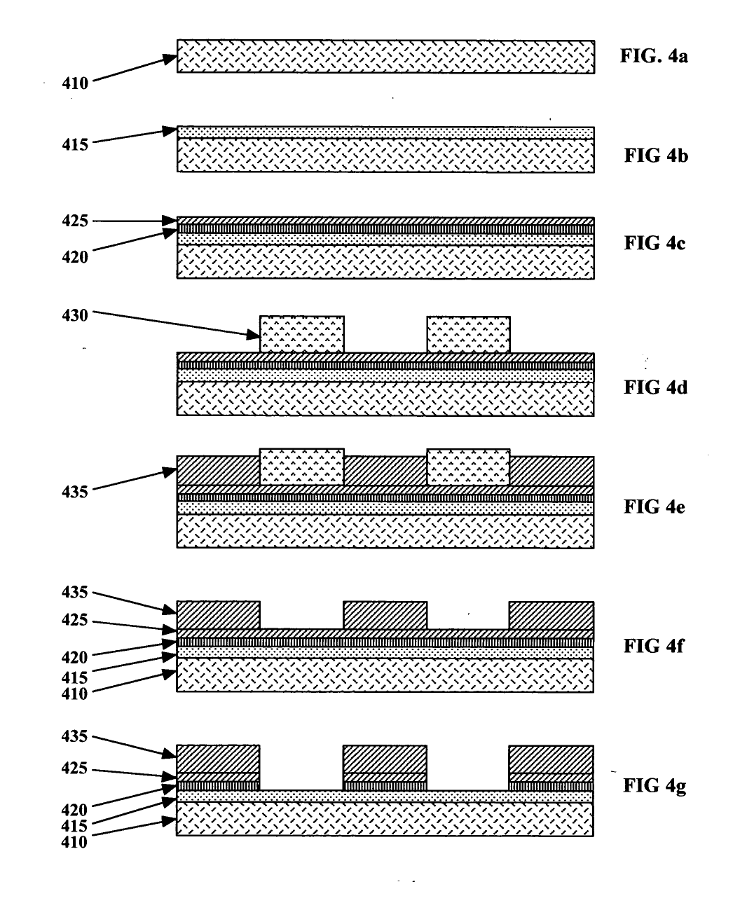

While a simplified sectional view of the disclosed fuel cell element is shown in FIG. 2. A more detailed description is disclosed for one specific embodiment in FIG. 4 through FIG. 10. Accordingly the specific processes described is one example of a variety of materials and fabrication techniques that are well known in microfabrication art and can be used for fabrication of the structure.

Referring to FIG. 4a a starting substrate may be of metal, semiconductor or insulator. Copper, silicon or glass respectively are examples of the substrate materials possible. If silicon is chosen then a first layer of silicon nitride 415 for example is deposited to insulate the current extractor lines from substrate 410. The insulator layer can be applied by Physical Vapor Deposition (PVD) or by Chemical Vapor Deposition (CVD) for example. Next in FIG. 4c an adhesion layer 420 and a preplate layer 425 is deposited on top of insulator layer 415 by PVD or CVD means. These materials may typically be chromium and copper respectively. In FIG. 4d a masking layer of photosensitive resist is applied to the wafer at a thickness somewhat greater than the thickness of layer 435 to be plated. The resist mask is patterned by lithographic conventional means to expose those areas that will become the current extractor conductors 435. Next in FIG. 4e the current conductor lines are plated up typically in a copper or nickel plating bath. Plated thickness of the lines meet the requirement for minimum voltage drop for extracted current and may be additionally used to conduct heat away from the proton exchange membrane. In FIG. 4f the resist mask is stripped by conventional means leaving copper current extractor lines on the bus layers 420 and 425. Next in FIG. 4g copper and chromium layers are etch removed using the much thicker plated copper layer as a mask. Some of the plated copper will also be removed.

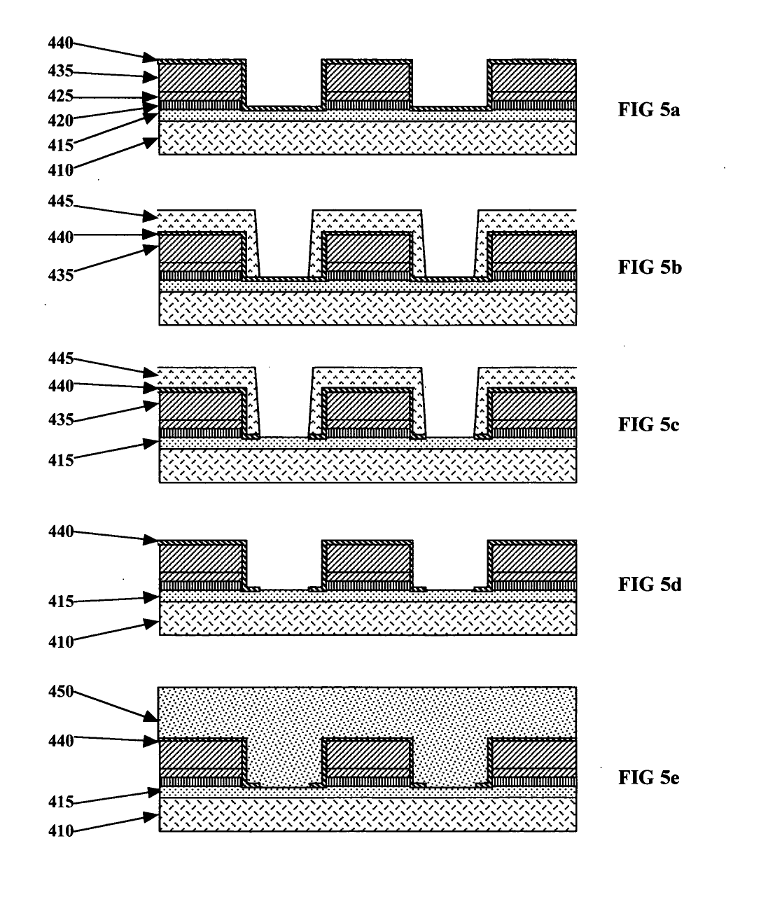

The fabrication process is continued in FIG. 5a wherein a barrier layer 440, if required, is applied typically by PVD or CVD conformably over the current collector lines and the space between. This material is typically a refractory conductor such tantalum nitride or titanium/tungsten/nitride alloy but may be more specifically determined by the nature of the corrosion expected between the electrode and the proton exchange membrane material with the fuel and oxidizer used. In FIG. 5b a photomasking step is performed to etch away the barrier material between the current extractor electrodes in order to avoid electrical shorts. In FIG. 5c the barrier is etched using either wet etching or dry etching technology common in the microfabrication industry. In FIG. 5d the resist mask is stripped. Next a solution of membrane material 450 is spin coated over the surface of the substrate to a thickness significantly greater than the height of current carrying lines 435. This material may be Nafion or other proton exchange material that is in solution form. Application may also be from Chemical Vapor Deposition using a membrane precursor. Other application techniques are dipping and doctor blading for example. After membrane material 450 deposition the membrane is heat cured to drive off excess solvent.

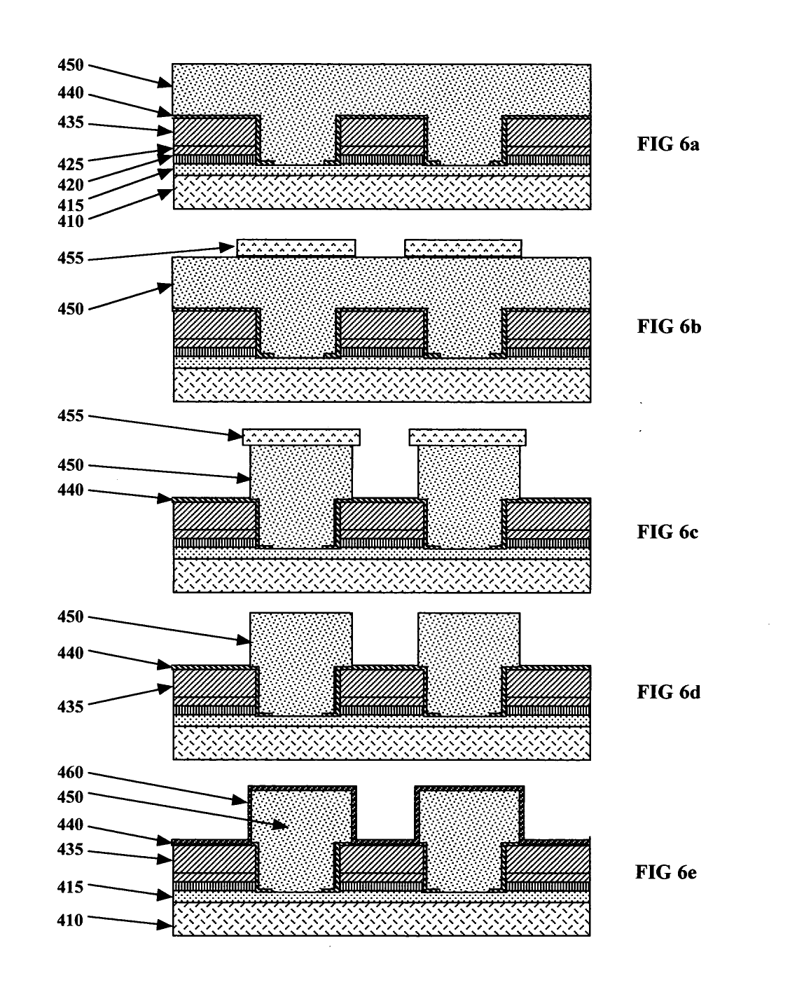

FIG. 6 continues the fabrication process wherein FIG. 6a represents the cured proton exchange membrane material. FIG. 6b shows a photomasking pattern required for anisotropically etching the membrane material down to barrier layer 440. FIG. 6c illustrates the anisotropic shape of the membrane sidewalls after etching using a resist mask to define channels in the membrane. Such anisotropic etching is accomplished using a Deep Reactive Ion Etching (DRIE) technique common in MEMS fabrication technology. A reactive gas such as a combination of O2, SF6 or CH3 in conjunction with He as a cooling gas is employed in a low pressure plasma system. In FIG. 6d the resist mask is stripped in a conventional stripper solution. As an option at this point in the process a thin layer of porous catalyst 460, FIG. 6emay be deposited over the surface of exposed structures to catalyze the fuel cell reaction at the interface between the proton exchange membrane and the electrode material. The catalyst is deposited by PVD or CVD technique. The material can be a Pt/Rb layer in the case of a Polymer Electrolyte Membrane Fuel Cell (PEMFC) or zirconia based electrolyte in the case of a Solid Oxide Fuel Cell SOFC.

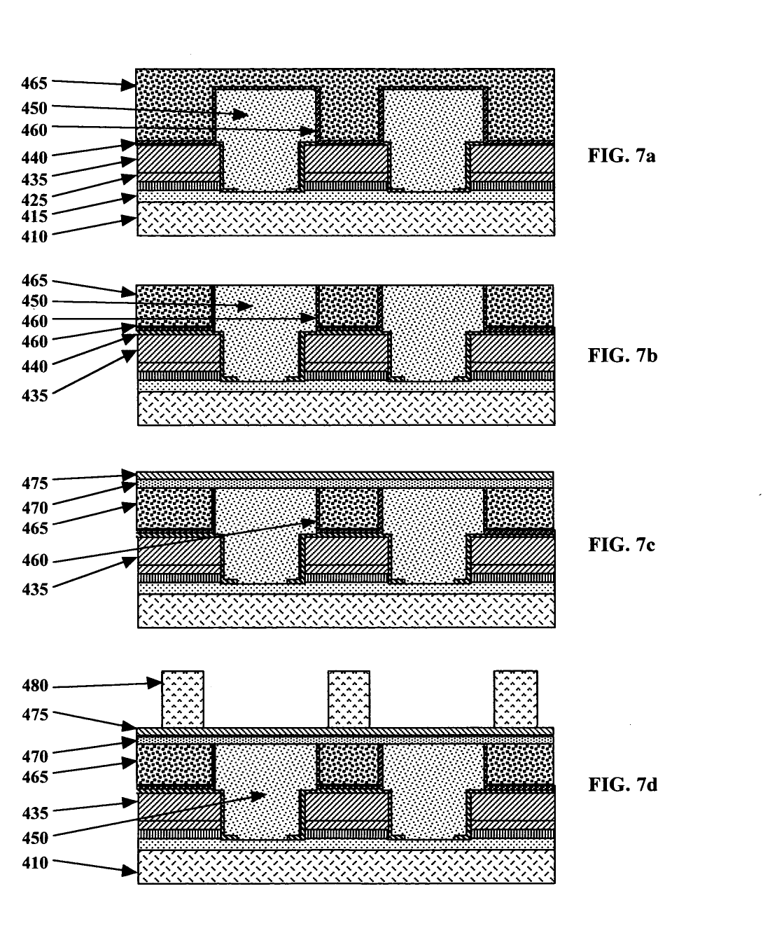

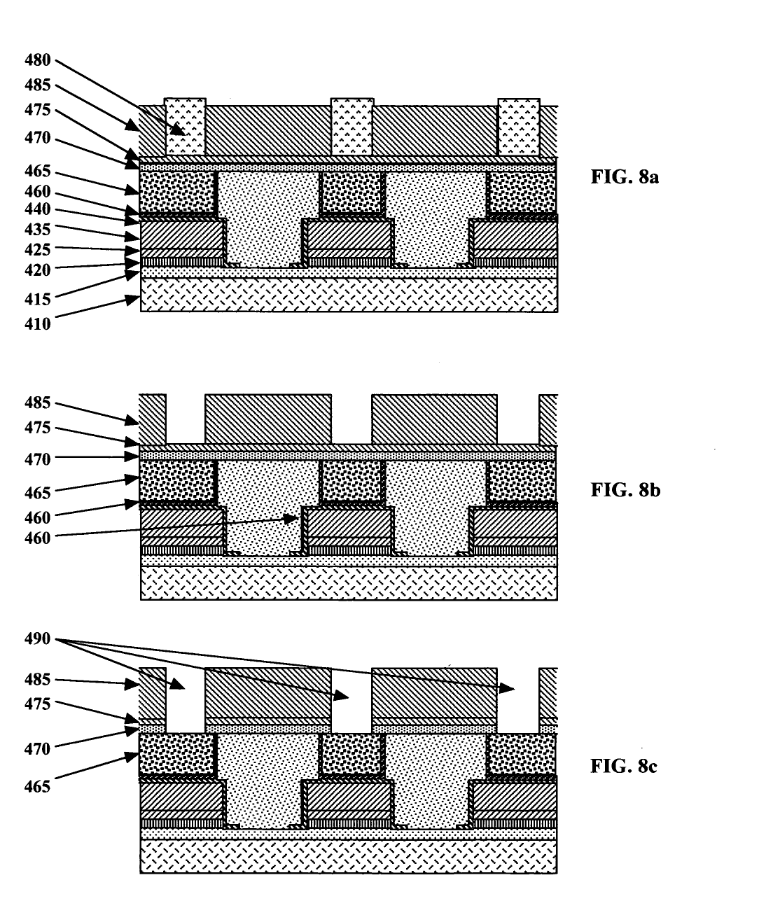

Referring now to FIG. 7 the fabrication process continues with FIG. 7a wherein a layer of electrode material 465 in the form of a slurry or thick liquid is applied by spin coating, dipping or doctor blading technique commonly found in the microfabrication industry. For PEMFC type fuel cells a heavy suspension of carbon in a carrier is utilized, for example, and in SOFC this may be a yttria stabilized zirconia material dispersed in a heavy solution, for example. After deposition this layer is heat cured at the appropriate temperature wherein it becomes densified. Next the structure is polished/planarized as shown in FIG. 7b so as to expose both membrane 450 and electrode material 465 as a planar surface. At the same time the thin layer of catalyst 460 is removed from the top surface of the membrane. The polish/planarization technique is commonly used in the semiconductor industry for planarization of on chip copper interconnect which is embedded in low K dielectric material similar to PEMFC material discussed herein. After adequate post polish surface cleaning an insulating layer 470 of silicon nitride or silicon dioxide is deposited by PVD or CVD the purpose being to electrically isolate fuel and oxidizer channel separator walls FIG. 8b, 485 from the electrode material. Insulating layer 470 is followed by deposition of adhesion layer and preplate layer 475 of chromium and copper respectively, for example using PVD or CVD technique. Adhesion and preplate layers 470 are shown as one layer for simplicity. Finally a photomasking layer 480 is applied to the surface of the copper preplate layer and photolithographically patterned, FIG. 7d, to expose the area of preplate copper that will form (when plated up) the walls of the fuel and oxidizer channels.

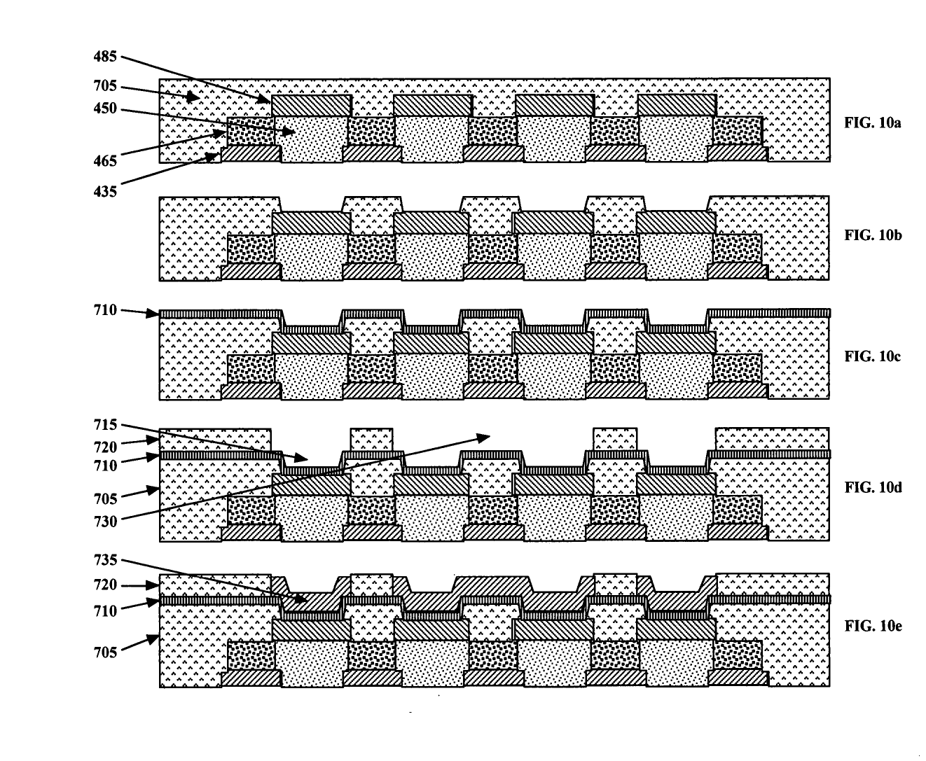

Now referring to FIG. 8a copper or nickel region 485 is plated up so as to form fuel and oxidizer channel walls of height generally slightly less than the thickness of the resist mask. Following wall plateup the masking layer is stripped FIG. 8b by conventional means leaving channel openings 490 between the channel walls. Next as shown in FIG. 8c layers 475 preplate layer and adhesion layer are etched away using the thick wall layer as an etch mask. Some minor etching of the wall layer will occur. Notice the widths of 485 and 490 are not shown to scale, 485 normally being narrower than 490. Layers 475 are wet or dry etched by techniques common in the microfabrication industry. Finally insulating layer 470 is etched using the remaining layers 475 and 485 as an etch mask. Removal of layer 470 is accomplished by either wet or dry plasma etch technique again a process common in the microfabrication industry. FIG. 8c completes the basic fuel cell structure which includes current extractor leads 435, proton exchange membrane 450, electrode with catalyst 465 and fuel and oxidizer channels 490 all fabricated on the single side of a planar substrate. Fabrication of a top cover plate integral with the basic cell completed previously continues specifically as illustrated in FIGS. 10, 11, 12, and 13.

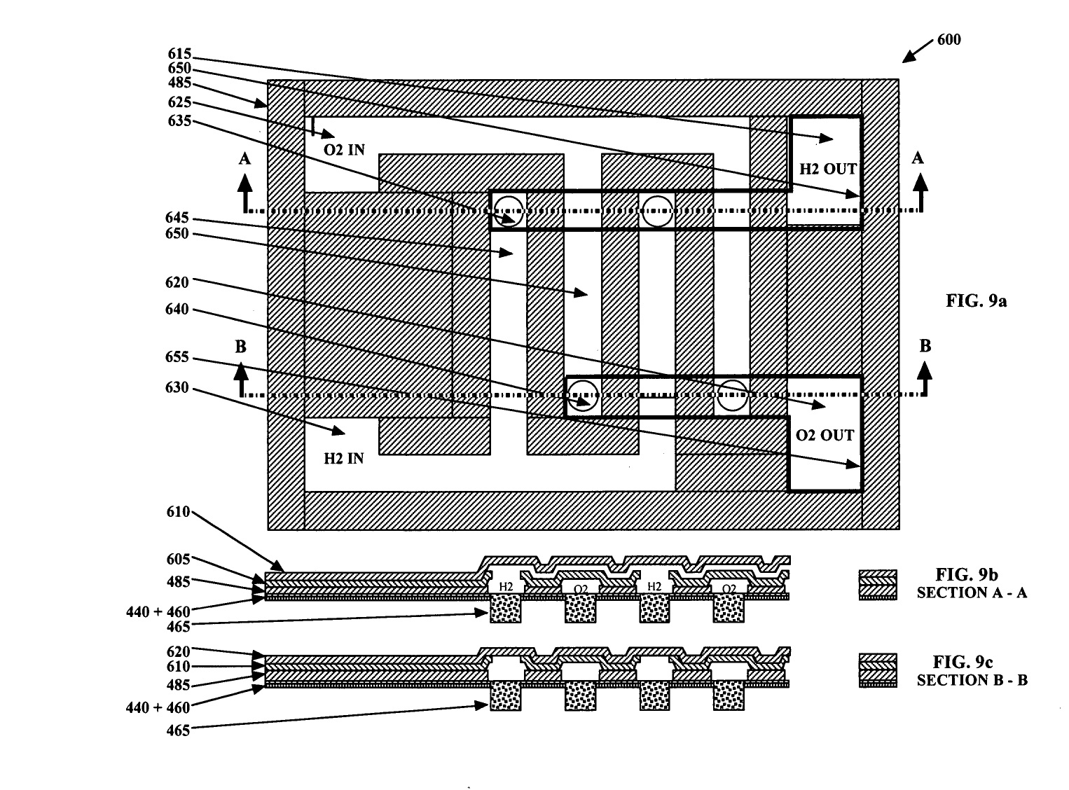

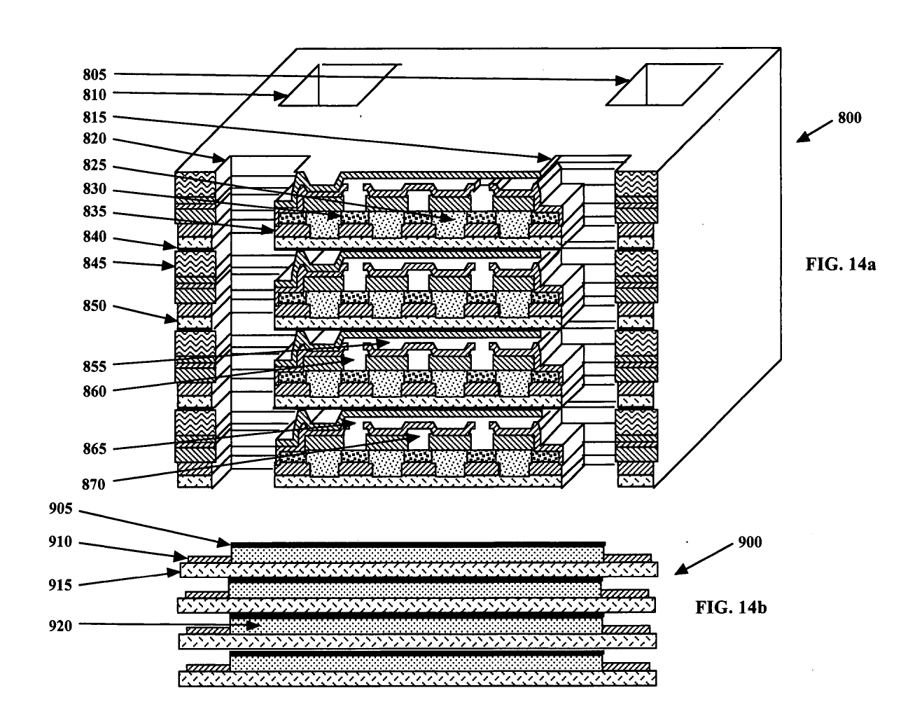

Reference to FIG. 9 will illustrate the strategy for forming an integral top cover plate containing vias and channels for removal of excess fuel and oxidizer from the active part of the cell. FIG. 9a shows a top view of a much reduced in complexity fuel cell cover. Illustrated are four square large manifold chambers 615, 620, 625 and 630 that are opened up through all deposited layers used to form the fuel cell. At the end of the process the substrate material is also removed in these areas to allow stacking of the individual micro fuel cells as shown in FIG. 14a. Manifold 625 feeds oxidizer (oxygen for example) into the comb structure channels 650 which are formed as a last step in FIG. 8c, 490. Oxidizer flows up through vias 640 to be formed in the cover structure and thence out through channel 655 (bold outline) to output manifold 620. The flow path is mirrored through a complimentary network of channels in the cover for the fuel. Input manifold 630 supplies fuel (hydrogen for example) to comb channels 645 then through vias 635 and out to fuel output manifold 615. The strategy is made more apparent through the examination of sections A-A and B-B as shown in FIGS. 9b and 9c where only the base electrode terminals 465 are shown for simplicity. The integral cover consists of three thick plated metallic layers. A first layer 485 represents the final layer 485 of FIG. 8c and forms fuel and oxidizer channels fabricated previously. A second 605 layer seals fuel and oxidizer channels 490 (fabricated at FIG. 8c) while supplying via holes 635 and 640 for passage of fuel and oxidizer into exit channels 650 and 655. A third layer 610 forms exit channels 650 and 655 in FIG. 9a to manifolds 615 and 620. respectively. Layers 485, 605 and 610 are formed by conventional photomasking and plating. The detailed fabrication sequence for the cover plate is illustrated in FIGS. 10, 11, 12 and 13.

The preferred embodiment of the integral cover fabrication begins as shown in FIG. 10a where a photomasking layer 705 is applied to the surface of the previously fabricated structures 465 and 485. For simplicity only the salient upper layers of the base fuel cell structure are shown in FIG. 10. Fuel and oxidizer channel walls 485 and electrode material 465 are exposed at the top surface of the starting structure. FIG. 10b illustrates the masking layer patterned to expose the metallic channel walls 485. Next an adhesion layer and preplate layer 710 is deposited over masking layer 705 and on the surface of channel wall structure 485. Typically these layers will be titanium and copper or nickel respectively and are deposited by vacuum evaporation on a cooled substrate if necessary, for example. Referring to FIG. 10d another masking layer 720 is applied to the surface of previously deposited layers 710 and the masking layer is patterned photolithographically to form via structures 715 (635 and 640 in FIG. 9a) in resist over the buried electrode layer. Finally in FIG. 10e a plateup layer of copper or nickel 735 for example is applied by well known plating techniques.

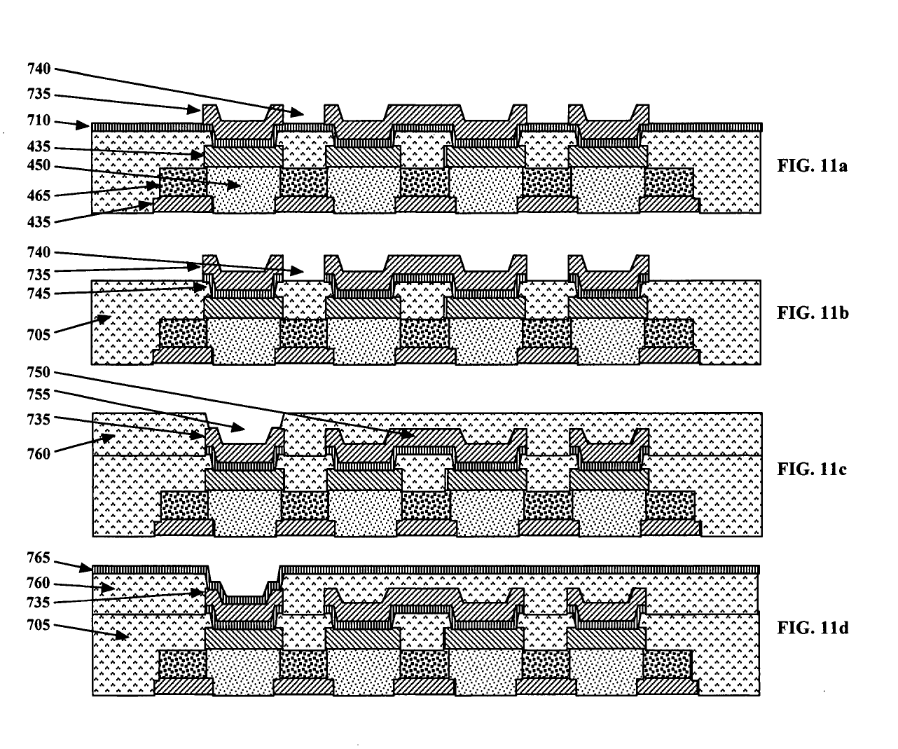

Cover fabrication process continues as exemplified in FIG. 11. The photomasking material of FIG. 10e is stripped from the substrate leaving the exposed plated layer 735 with adhesion and preplate layer 710 between. Next adhesion and preplate layer 710 is etched using, typically, wet chemistry. Another photomasking layer 760 is applied in FIG. 11c and photolithographically exposed and developed to expose previously plated area 735. Finally another adhesion and preplate film 765 is deposited by vacuum evaporation onto photomasking region 760 and the previously plated copper or nickel layer 735 for example. While not intuitively obvious from FIG. 11d a substantial amount of layers 765 are in contact with previously plated layer 735 thus by suitable mask design typically more than half of layer 765 is supported by plated layer 735.

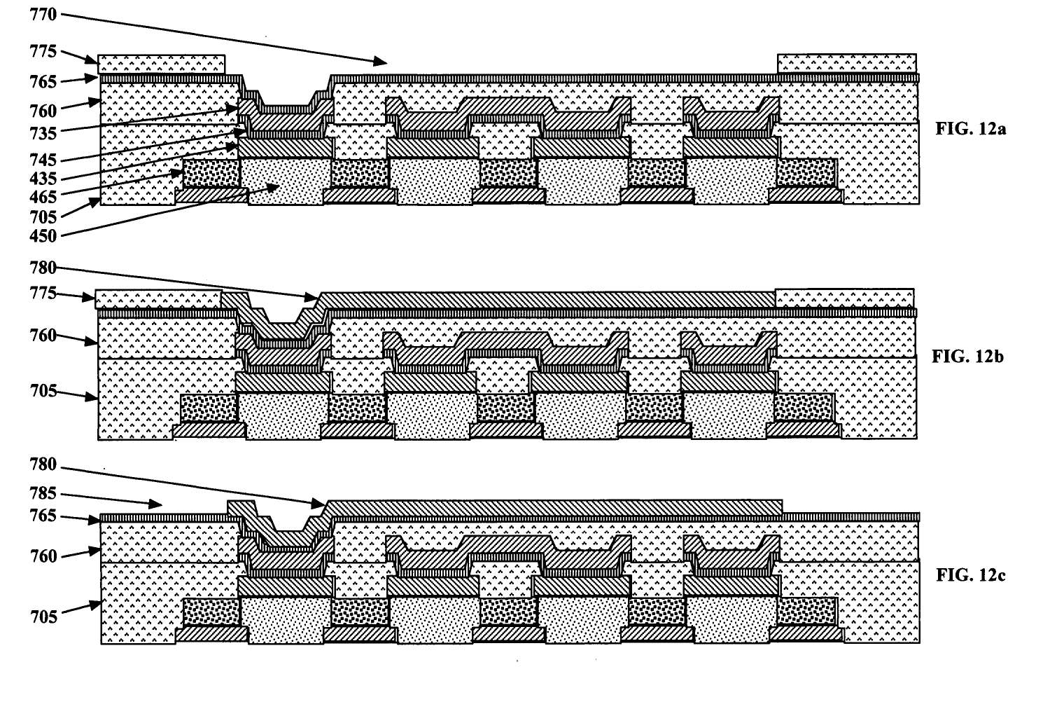

FIG. 12a adds another layer of photomask 775 to adhesion and preplate layer 765 and defines plateup area 770 of the second metal layer of the top layer 780. FIG. 12b shows the plated up layer 780, the last metal layer of the cover structure. Finally the photomask is removed from area 785 of FIG. 12c by conventional resist stripping means using an organic solvent.

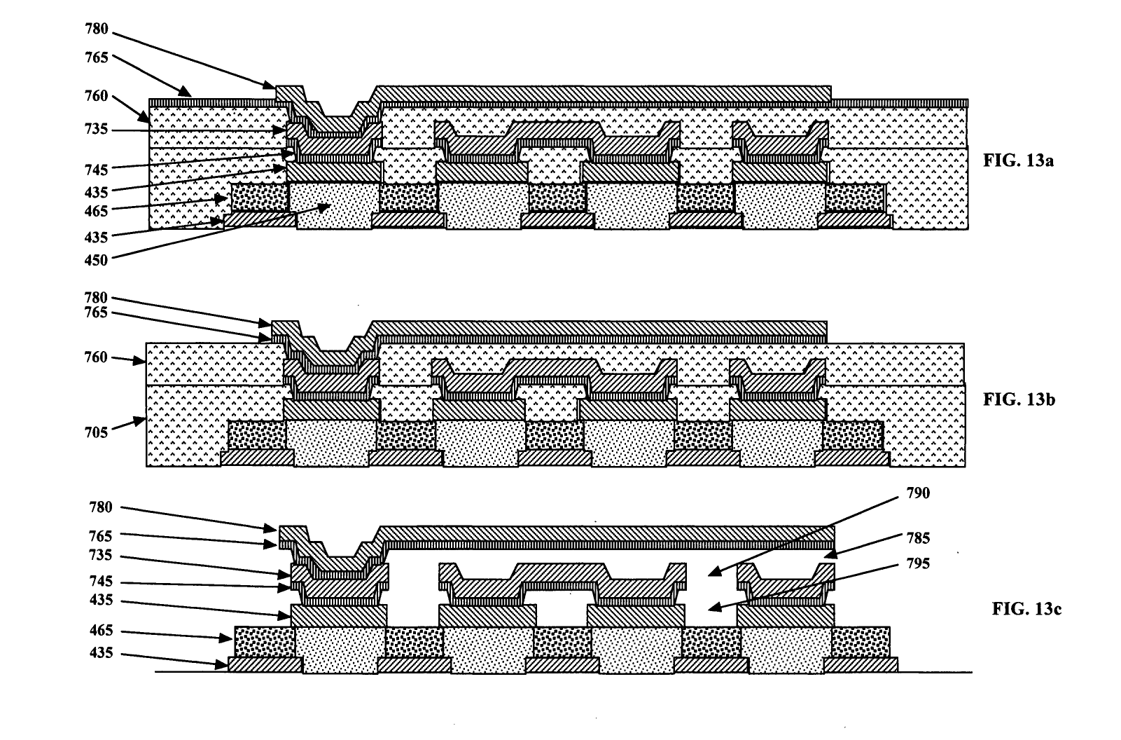

Final processes for cover fabrication are shown in FIG. 13. FIG. 13b indicates removal of exposed preplate and adhesion layer 765 using the plated copper or nickel thick film as a mask. Removal is accomplished by wet etching. As a final step in cover fabrication buried layers of photomask material 705 and 760 left over as temporary support for enabling via and channel fabrication are removed through slow dissolution in hot solvent stripper such as an NMP commercial based stripper. Since some of the photomask is buried in small channels the dissolution solvent is stirred and ultrasonic agitation is used over a period of several hours. The completed fuel cell element is shown in FIG. 2 in cross section and has been fully fabricated by sequential processing on a planar substrate. Such a series of process steps are highly amenable to a semiconductor manufacturing facility.

To complete the fuel cell element fabrication the cover side of the fuel cell array is photomasked and the manifold channels are opened in the resist mask exposing the substrate surface. The back side of the substrate may be masked with a blanket unpatterned masking layer if necessary to avoid backside etching during manifold channel etching. The substrate is then either wet or dry etched completely through from the structure side rendering four channels through a unit fuel cell element. Finally the structure is stripped of masking material to provide for an array of elemental micro fuel cells that can be singulated by standard semiconductor sawing or laser scribing technology for example.

Prior to etching the manifold through channels the substrate may be thinned by lapping and polishing in order to reduce the stacking dimensions of an array of stacked fuel cells. An individual fuel cell may be as thin as 0.25 mm by virtue of lap thinning for example. Thus a stack of 20 to 30 fuel cell elements per cm. of stacking height is feasible while allowing for a thin layer of stacking adhesive between each individual cell. Hermetic sealing between elemental cells is accomplished by soldering, brazing, adhesive or epoxy bonding depending on the operating temperature of the fuel cell. Such hermetic sealing techniques are well known in semiconductor Back End Of the Line (BEOL) technology.

FIG. 14a illustrates a stack of four reduced complexity fuel cell elements with part of the front sectioned to show functionality. The elemental fuel cells are sealed together with a layer 840 of solder, braze or adhesive for example. The fuel and oxidizer manifold channels 805, 810, 815 and 820 are aligned such that the cavities are propagated through the entire body of the cell stack providing means for fuel and oxidizer access to each stacked fuel cell element. Such arrangement allows tubulations to be attached to the top face of the stack by conventional means such as soldering, brazing, epoxy seal or adhesive seal. The bottom end of the cell stack may also be provided with tubulations for connection to balance of plant if required or can be blanked off using a solid plate.

FIG. 14b illustrates a method of stacking individual fuel cell elements such that current extraction leads 210 and 215 of FIG. 2 are exposed at the edge of the stack for connection to an external load.

Current state of the art in PEMFC technology indicates an average power available per square cm. of cell surface to be about 0.5 watts/cm. sq. of active membrane. Typical output values of 1 amp at 500 mV are achievable. Thus a stack of 30 thinned substrate fuel cell elements as described in this disclosure where each element is of a size to yield about a 1 sq. cm. of reaction area can provide 15 watts of power running efficiently on hydrogen and air.

While specific embodiments of the described invention have been disclosed along with a preferred method of manufacture the invention may be fabricated with other materials and processes that are known in the microfabrication art and the disclosed materials and processes are not intended to be limiting. Process and materials modification will become apparent to those skilled in the art.

1. We claim a fuel cell consisting of positive and negative electrodes, electrical current extractor lines, electrode catalyst, ion exchange membrane, fuel and oxidizer channels, integral channeled top plate feeding fuel and oxidizer manifold supply chambers with said structures all disposed on one side of a single (monolithic) substrate and all said structures fabricated sequentially on the said single side of a monolithic substrate.

2. The fuel cell of claim 1 wherein the ion exchange process takes place predominantly in a direction parallel to the surface of a single monolithic substrate.

3. The fuel cell of claim 1 wherein the dimensions of the ion exchange membrane orthogonal to the plane of the substrate and perpendicular to ion flow may be much larger than the dimensions in the plane of the substrate in order to facilitate a larger surface area for ion exchange and to yield higher output power density per unit area of substrate.

4. The fuel cell of claim 1 wherein such cell consists of a single fuel cell or a multiplicity of single fuel cells disposed over a single monolithic substrate.

5. The fuel cell of claim 1 wherein all components described are disposed on one side of a monolithic substrate.

6. The fuel cell of claim 1 wherein the substrate is comprised of insulating, semi-insulating, semiconducting, or conductive material.

7. The fuel cell of claim 1 wherein singulated fuel cell elements or arrays of unsingulated fuel cell elements are stacked and interconnected to form a higher output power module than would be available from a single fuel cell element or an array of fuel cell elements on a single substrate.

8. The fuel cell of claim 1 wherein individual fuel cells within a single substrate are electrically interconnected to yield a cell array connected variously in series or parallel to provide a variable voltage or current range.

9. The fuel cell of claim 1 wherein manifold supply chambers provide for stacking of individual fuel cells or arrays of fuel cells whereby such manifold chambers are in registration thus allowing the passage of fuel and oxidizer through multiply stacked fuel cells or arrays of fuel cells.

10. The fuel cell of claim 1 wherein a multiplicity of fuel cells fabricated on a single substrate can be singulated then stacked by hermetically bonding one to another.

11. The fuel cell of claim 1 wherein a multiplicity of single fuel cells on a single substrate are interconnected such that electrical current extractor lines are routed to the edge of a single substrate to provide connection to external devices or electrical loads.

12. The fuel cell of claim 1 wherein a monolithic semiconductor substrate contains preexisting active semiconductor circuits for the purpose of controlling operation of the fuel cell.

13. The fuel cell of claim 1 wherein the monolithic substrate contains active MEMS type devices for controlling mechanical functions of the fuel cell.

14. The fuel cell of claim 1 wherein all the functional elemental parts of said fuel cell or cells are fabricated by sequential processing on one side of a single monolithic substrate.

15. The fuel cell of claim 1 wherein the fuel cell structure may be a Proton Exchange Membrane (PEMFC) type or a Solid Oxide Type (SOFC) or Solid Polymer Type (SPFC), depending on the selection of fabrication materials.

16. The fuel cell of claim 1 wherein the fuel source is comprised of alcohols, hydrogen gas, or other fuels containing redox pairs.

17. The fuel cell of claim 1 wherein the oxidizer source is air or oxygen.

18. The fuel cell of claim 1 wherein the operating temperature range may be from 80° C. to 800° C. depending on the type of said cell and the material system used.

19. The fuel cell of claim 1 wherein the anode and cathode electrodes are alternated in a single plane on a monolithic single substrate.

20. The fuel cell of claim 1 wherein the fuel and oxidizer channels and electrical conductors are configured in a comb pattern.

21. The fuel cell of claim 1 wherein the lateral dimensions of the electrical conductors, the membrane material, the electrodes and the fuel and oxidizer channel separators are within the range of from 5 μm to 1 mm. for the purpose of using standard semiconductor and microfabrication manufacturing techniques.

22. The fuel cell of claim 1 wherein the electrical current extractor lines and the substrate are of high thermal conductivity for the purpose of removing heat from the active region of the fuel cell.

23. The fuel cell of claim 1 wherein structure buildup is accomplished by methods common in the semiconductor and MEMS fabrication industry including but not limited to physical vapor deposition, chemical vapor deposition, plating, spin coating, dipping, spraying and cladding.

24. The fuel cell of claim 1 whereby structure patterning is accomplished by standard semiconductor or MEMS photomasking technique followed by etch removal or additive deposition techniques.

25. The fuel cell of claim 1 wherein masking is accomplished using standard photoresist and lithography printing techniques common in the semiconductor and MEMS fabrication industry.

26. The fuel cell of claim 1 wherein subtractive removal is accomplished using either laser ablation, stamping, ultrasonic grinding, lapping or polishing, machining, or wet or dry etching.

27. The fuel cell of claim 1 wherein subtractive feature formation is accomplished by vacuum etching processes such as sputter etching, reactive ion etching, reactive ion beam etching, deep reactive ion etching.

28. The fuel cell of claim 1 wherein anode and cathode electrical conductor lines are comprised of plated copper, gold, nickel or palladium or a combination of those.

29. The fuel cell of claim 1 wherein an inert corrosion barrier is comprised of a patterned refractory conductor such as tantalum nitride, titanium-tungsten nitride, or rhodium.

30. The fuel cell of claim 1 wherein a membrane material is deposited by spin coating, dipping, or chemical vapor deposition.

31. The fuel cell of claim 1 wherein the electrode material is applied to anisotropically etched holes in a membrane by spin coating, dipping or doctor blading, followed by heat curing.

32. The fuel cell of claim 1 wherein an insulating barrier layer is applied to the surface of conductive elements by vacuum deposition, chemical vapor deposition or other conventional means for the purpose of electrically insulating one element from another or eliminating corrosion between dissimilar materials.

33. The fuel cell of claim 1 wherein metallic layers are built by plating copper, nickel, gold, or a combination thereof, for example.
